(19) United States
(12) Patent Application Publication
(10) Pub. No.: US 2012/0147096 A1
(43) Pub. Date: Jun. 14, 2012

(54) INKJET HEAD

(75) Inventor: Keizaburo Yamamoto, Shizuoka (JP)

(73) Assignee: TOSHIBA TEC KABUSHIKI KAISHA, Tokyo (JP)

(21) Appl. No.: 13/316,837

(22) Filed: Dec. 12, 2011

(30) Foreign Application Priority Data
Dec. 13, 2010 (JP) 2010-276837

(51) Int. Cl. B41J 2/05

(52) U.S. Cl. 347/61

(57) ABSTRACT

An inkjet head includes: an ink ejecting section including an ink chamber to which ink is supplied, a driving element provided in the ink chamber, a nozzle opened to the ink chamber, and a wire connected to the driving element, the ink ejecting section being configured to eject the ink in the ink chamber from the nozzle using the driving element; an ink passage section attached to the ink ejecting section and including a supply passage, which is connected to the ink chamber and through which the ink supplied to the ink chamber passes, and a discharge passage, which is connected to the ink chamber and through which the ink discharged from the ink chamber passes; and an IC electrically connected to the driving element via the wire and thermally connected to the ink passage section.

### CROSS-REFERENCE TO RELATED APPLICATION(S)

This application is based upon and claims the benefit of priority from the prior Japanese Patent Application No. 2010-276837, filed on Dec. 13, 2010, the entire contents of which are incorporated herein by reference.

### FIELD

Embodiments described herein relate generally to an inkjet head.

### BACKGROUND

Some inkjet printers have a configuration for circulating ink through an inkjet head. The inkjet head of this type includes a substrate, a frame-like section attached to the substrate, and a nozzle plate attached to the frame-like section.

An ink chamber is formed on the inside of the inkjet head by the substrate, the frame-like section, and the nozzle plate. Plural driving elements are attached to the substrate to be arranged in the ink chamber. The driving elements eject ink, which is supplied to the ink chamber, from nozzles provided in the nozzle plate.

The substrate includes a supply port for supplying the ink to the ink chamber and a discharge port for discharging the ink from the ink chamber. The driving elements are present between the supply port and the discharge port. The ink supplied from the supply port to the ink chamber is discharged from the nozzles of the inkjet head by the driving elements. The residual ink is collected in an ink tank from the discharge port.

The inkjet head is mounted with an IC configured to control the driving elements. Since the IC generates heat during use, a cover of the inkjet head is formed in a heat sink shape. The heat generated by the IC is dissipated through the cover.

### DESCRIPTION OF THE DRAWINGS

FIG. 1 is a perspective view of an inkjet head according to a first embodiment;

FIG. 2 is a disassembled perspective view of the inkjet head according to the first embodiment;

FIG. 3 is a sectional view of the inkjet head according to the first embodiment taken along line F3-F3 shown in FIG. 1;

FIG. 4 is a plan view of a manifold, a substrate, and a frame member in the first embodiment;

FIG. 5 is a disassembled perspective view of an inkjet head according to a second embodiment;

FIG. 6 is a perspective view of an inkjet head according to a third embodiment;

FIG. 7 is a disassembled perspective view of the inkjet head according to the third embodiment;

FIG. 8 is a sectional view of the inkjet head according to the third embodiment taken along line F8-F8 shown in FIG. 6;

FIG. 9 is a plan view of a manifold, a substrate, and a frame member in the third embodiment; and

FIG. 10 is a disassembled perspective view of an inkjet head according to a fourth embodiment.

### DETAILED DESCRIPTION

According to an embodiment, an inkjet head includes an ink ejecting section including an ink chamber to which ink is supplied, a driving element provided in the ink chamber, a nozzle opened to the ink chamber, and a wire connected to the driving element. The ink ejecting section is configured to eject the ink in the ink chamber from the nozzle using the driving element as an ink passage section attached to the ink ejecting section and including a supply passage. The supply passage is connected to the ink chamber and through which the ink supplied to the ink chamber passes. A discharge passage, which is connected to the ink chamber and through which the ink discharged from the ink chamber passes an integrated circuit (IC) electrically connected to the driving element via the wire and thermally connected to the ink passage section.

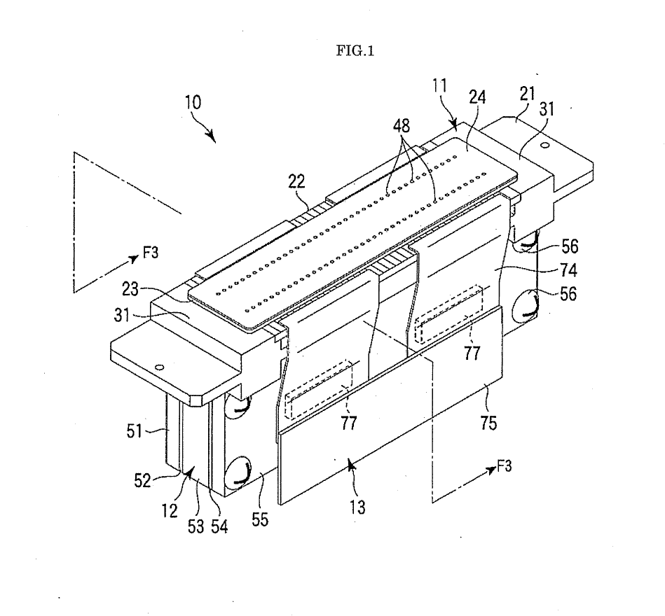

A first embodiment is explained below with reference to FIGS. 1 to 4.

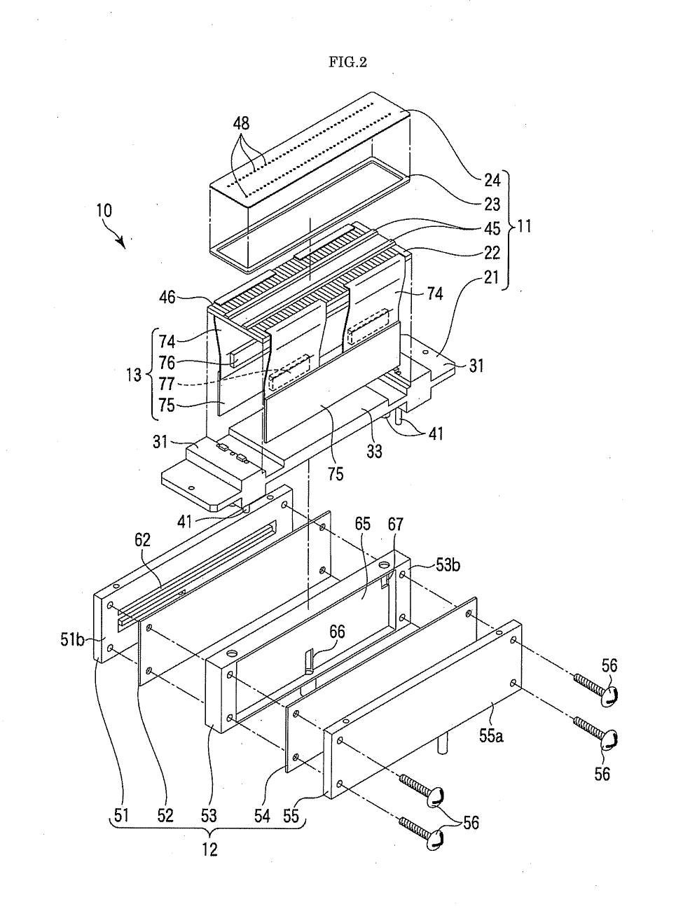

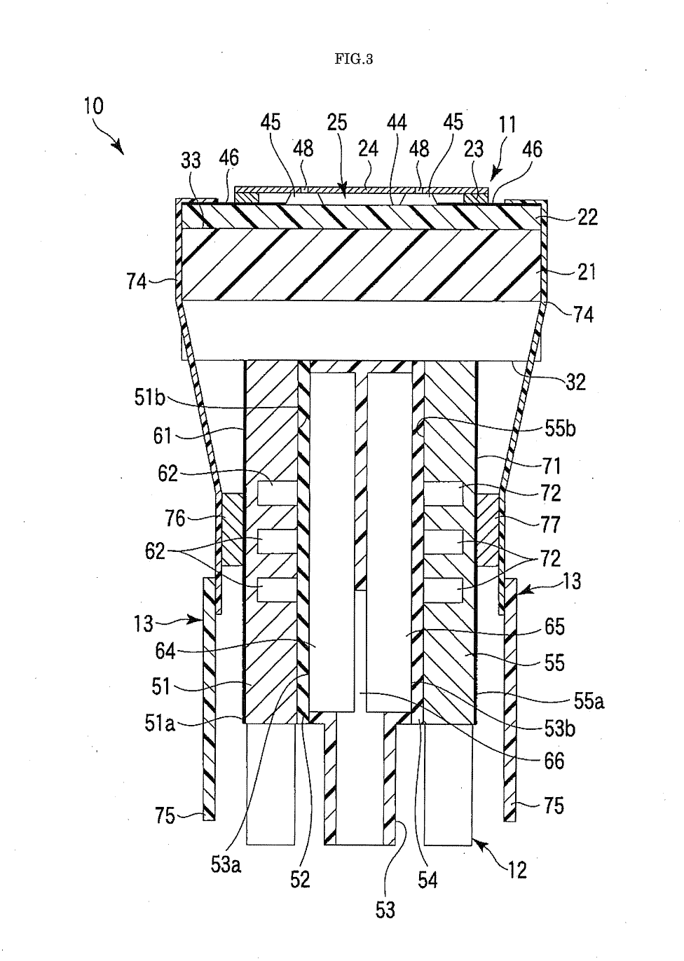

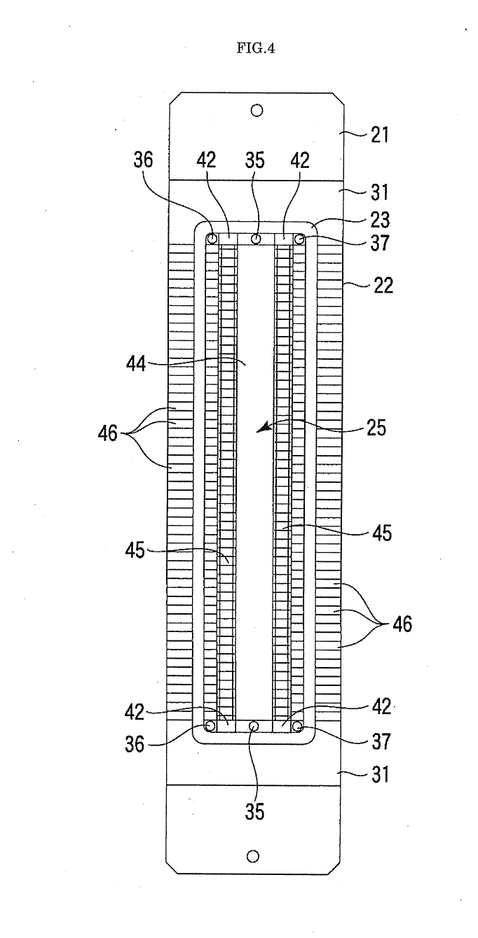

FIG. 1 is a perspective view of an inkjet head 10. FIG. 2 is a disassembled perspective view of the inkjet head 10. FIG. 3 is a sectional view of the inkjet head 10 taken along line F3-F3 shown in FIG. 1. FIG. 4 is a plan view of the manifold 21, the substrate 22, and the frame member 23.

As shown in FIG. 1, the inkjet head 10 includes an ink ejecting section 11, an ink passage section 12, and a pair of circuit modules 13. The ink passage section 12 and the pair of circuit modules 13 are attached to the ink ejecting section 11.

As shown in FIG. 2, the ink ejecting section 11 includes a manifold 21, a substrate 22, a frame member 23, and a nozzle plate 24. As shown in FIG. 3, the ink ejecting section 11 includes an ink chamber 25 on the inside thereof. The frame member 23 and the nozzle plate 24 are laid one on top of the other on the substrate 22. The ink chamber 25 is surrounded by the substrate 22, the frame member 23, and the nozzle plate 24. Ink for printing is supplied to the ink chamber 25.

The manifold 21 includes a pair of first surfaces 31 (shown in FIG. 2), a pair of second surfaces 32, and a fitting section 33. The pair of first surfaces 31 and the pair of second surfaces 32 are formed flat. The pair of second surfaces 32 are respectively provided on the opposite side of the first surfaces 31 corresponding thereto. The fitting section 33 is provided between the pair of first surfaces 31 and is recessed from the first surfaces 31. The substrate 22 is fit in the fitting section 33.

As shown in FIG. 4, a pair of supply holes 35, a pair of discharge holes 36, and a pair of second discharge holes 37 are provided in the first surfaces 31 of the manifold 21. The pair of supply holes 35, the pair of first discharge holes 36, and the pair of second discharge holes 37 are opened to the ink chamber 25. The supply holes 35 are holes for supplying the ink to the ink chamber 25. The first and second discharge holes 36 and 37 are holes for discharging the ink remaining in the ink chamber 25 after use.

As shown in FIG. 2, plural pipes 41 project from the pair of second surfaces 32 of the manifold 21. The plural pipes 41 respectively communicate with the supply holes 35, the first discharge holes 36, and the second discharge holes 37 corresponding thereto.

As shown in FIG. 4, the supply holes 35 are arranged between the first discharge holes 36 and the second discharge holes 37. Partition sections 42 are present between the supply holes 35 and the first discharge holes 36 and between the supply holes 35 and the second discharge holes 37. The partition sections 42 are protrusions that project from the first surfaces 31 of the manifold 21.

The substrate 22 is formed of a ceramic, such as alumina, in a suitable shape, such as a rectangular plate shape in this instance. The substrate 22 has a flat surface 44. When the substrate 22 is fit in the fitting section 33 of the manifold 21, the surface 44 forms a plane continuous to the pair of first surfaces 31 of the manifold 21. A pair of driving elements 45 and plural wiring patterns 46 are present on the surface 44 of the substrate 22. The wiring patterns 46 are an example of wires. The wiring patterns 46 are formed of, for example, a nickel thin film formed by electroless plating.

The pair of driving elements 45 are piezoelectric elements formed of a suitable material in a suitable shape, for example, lead zirconate titanate (PZT) in a bar shape. The pair of driving elements 45 are arranged side by side in parallel in the ink chamber 25. The driving elements 45 are secured between the partition section 42 of one first surface 31 and the partition section 42 of the other first surface 31 of the manifold 21. Ends of the driving elements 45 are respectively in contact with the partition sections 42. Plural grooves are formed in the driving elements 45. The grooves form pressure chambers for ejecting the ink.

The plural wiring patterns 46 respectively extend from sides of the substrate 22 toward the driving elements 45. The wiring patterns 46 are connected to electrodes respectively provided in the plural grooves of the driving elements 45.

The frame member 23 is bonded to the surface 44 of the substrate 22 and the first surfaces 31 of the manifold 21. The frame member 23 surrounds the ink chamber 25. The inner wall of the frame member 23 is in contact with the plural partition sections 42 of the manifold 21.

As shown in FIG. 2, the nozzle plate 24 is formed of a rectangular film made of, for example, polyimide. The nozzle plate 24 is bonded to the frame member 23 and surrounds the ink chamber 25.

Plural nozzles 48 are provided in the nozzle plate 24. The nozzles 48 are holes formed in the nozzle plate 24 and are opened to the ink chamber 25. The plural nozzles 48 are arranged to respectively correspond to the plural grooves provided in the pair of driving elements 45 (that is, each nozzle corresponds with a single groove). The ink pressed in the pressure chambers formed by the grooves of the driving elements 45 is ejected from the nozzles 48 corresponding to the grooves.

As shown in FIG. 2, the ink passage section 12 includes a first discharge side member 51, a first rubber plate 52, a supply side member 53, a second rubber plate 54, a second discharge side member 55, and four fixing members 56. The first rubber plate 52 and the second rubber plate 54 constitute an example of a heat insulating member.

The first discharge side member 51 is formed of a suitable material in a suitable shape, for example, aluminum in a rectangular black shape. The first discharge side member 51 may be formed of, for example, a good conductor of heat such as a metal such as copper or iron having high heat conductivity or other materials. As indicated by the thick line in FIG. 3, an outer surface 51a of the first discharge side member 51 is coated with an insulating film 61.

The first discharge side member 51 includes a first discharge passage 62. The first discharge passage 62 includes a groove opened in an inner surface 51b of the first discharge side member 51 and formed to meander. One end of the first discharge passage 62 is a pair of holes opened in one end face of the first discharge side member 51. The pipes 41 of the manifold 21 communicating with the first discharge holes 36 are respectively inserted into the holes. The other end of the first discharge passage 62 is a hole opened in the other end face of the first discharge side member 51 and is connected to an ink tank in which the ink is stored. The first discharge passage 62 is connected to the ink chamber 25. The ink discharged from the ink chamber 25 to the ink tank passes through the first discharge passage 62.

The supply side member 53 is formed of a suitable material, for example, synthetic resin in a rectangular block shape. The supply side member 53 may be formed of the same as the material of the first discharge side member 51, such as aluminum, or other materials.

As shown in FIG. 3, the supply side member 53 includes a first supply passage 64 and a second supply passage 65. The first supply passage 64 is a recess opened in one side 53a of the supply side member 53. The second supply passage 65 is a recess opened in the other side 53b of the supply side member 53. As shown in FIG. 2, the first supply passage 64 and the second supply passage 65 are connected by a branching section 66 and a pair of merging sections 67. The branching section 66 and the pair of merging sections 67 are openings provided in a partition wall that separates the first supply passage 64 from the second supply passage 65.

On one end of the first and second supply passages 64 and 65 are a pair of holes opened in one end face of the supply side member 53 and communicate with the pair of merging sections 67. The pipes 41 of the manifold 21 communicating with the supply holes 35 are respectively inserted into open holes of the first and second supply passages 64 and 65. On the other end of the first and second supply passages 64 and 65 are holes opened in the other end face of the supply side member 53 and communicate with the branching section 66. The other ends of the first and second supply passages 64 and 65 are connected to the ink tank in which the ink is stored. The first and second supply passages 64 and 65 are connected to the ink chamber 25. The ink supplied from the ink tank to the ink chamber 25 passes through the first and second supply passage 64 and 65.

The first rubber plate 52 is interposed between the first discharge side member 51 and the supply side member 53. The first rubber plate 52 is in contact with the inner surface 51b of the first discharge side member 51 and one side 53a of the supply side member 53. The first rubber plate 52 seals the first discharge passage 62 to the first supply passage 64 and insulates the first discharge side member 51 from the supply side member 53. The first rubber plate 52 is formed of, for example, synthetic rubber in a rectangular plate shape. The first rubber plate 52 is not limited to this construction, and can be formed of other materials having heat insulation properties and capable of sealing the passages.

The second discharge side member 55 is formed of a suitable material, for example, aluminum in a rectangular block shape. The second discharge side member 55 can be formed of a good conductor of heat such as a metal such as copper or iron having high heat conductivity or other materials. As indicated by a thick line in FIG. 3, an outer surface 55a of the second discharge side member 55 is coated with an insulating film 71.

As shown in FIG. 3, the second discharge side member 55 includes a second discharge passage 72. The second discharge passage 72 includes a groove opened in an inner surface 55b of the second discharge side member 55 and formed to meander as in the first discharge passage 62. One end of the second discharge passage 72 is a pair of holes opened in one end face of the second discharge side member 55. The pipes 41 of the manifold 21 communicating with the second discharge holes 37 are respectively inserted into the holes. The other end of the second discharge passage 72 is a hole opened in the other end face of the second discharge side member 55 and is connected to the ink tank in which the ink is stored. The second discharge passage 72 is connected to the ink chamber 25. The ink discharged from the ink chamber 25 to the ink tank passes through the second discharge passage 72.

The second rubber plate 54 is interposed between the supply side member 53 and the second discharge side member 55 and is in contact with the other side 53b of the supply side member 53 and the inner surface 55b of the second discharge side member 55. The second rubber plate 54 seals the second supply passage 65 to the second discharge passage 72 and insulates the supply side member 53 from the second discharge side member 55. The second rubber plate 54 is formed of, for example, synthetic rubber in a rectangular shape. The second rubber plate 54 is not limited to this construction and can be formed of other materials having heat insulating properties and capable of sealing the passages.

As shown in FIG. 2, the fixing members 56 are screws and pierce through four corners of each of the first discharge side member 51, the first rubber plate 52, the supply side member 53, the second rubber plate 54, and the second discharge side member 55. The first discharge side member 51, the first rubber plate 52, the supply side member 53, the second rubber plate 54, and the second discharge side member 55 are fixed by the fixing members 56 and form the ink passage section 12. The first discharge side member 51, the first rubber plate 52, the supply side member 53, the second rubber plate 54, and the second discharge side member 55 are not always fixed by the fixing members 56 and can be fixed by other means such as an adhesive.

The pair of circuit modules 13 include plural flexible printed wiring boards (hereinafter referred to as “FPCs”) 74, a pair of rigid printed wiring boards (hereinafter referred to as “PCBs”) 75, plural first driver ICs 76, and plural second driver ICs 77. The first and second driver ICs 76 and 77 are an example of ICs.

The FPCs 74 have flexibility. One ends of the FPCs 74 are respectively connected to the plural wiring patterns 46 provided on the substrate 22. The other ends of the FPCs 74 are respectively connected to the PCBs 75.

The first and second driver ICs 76 and 77 are packaged by, for example, a COF (chip on film) technique or a TAB (tape automated bonding) technique. The first driver ICs 76 are mounted on the FPCs 74 by, for example, an anisotropic conductive film (ACF) to be opposed to the first discharge side member 51. Similarly, the second driver ICs 77 are mounted on the FPCs 74 by, for example, an ACF, to be opposed to the second discharge side member 55. The first and second driver ICs 76 and 77 are electrically connected to the driving elements 45 via the FPCs 74 and the wiring patterns 46.

As shown in FIG. 3, the first driver ICs 76 are in contact with the first discharge side member 51 via the insulating film 61. Consequently, the first driver ICs 76 are thermally connected to the first discharge side member 51. The first driver ICs 76 are arranged in a position close to the first discharge passage 62. That is, close enough to (describe here what function is achieved by the closeness).

Similarly, the second driver ICs 77 are in contact with the second discharge side member 55 via the insulating film 71. Consequently, the second driver ICs 77 are thermally connected to the second discharge side member 55. The second driver ICs 77 are arranged in a position close to the second discharge passage 72. That is, close enough to (describe here what function is achieved by the closeness).

The first driver ICs 76 are fixed by, for example, bonding in a state in which the first driver ICs 76 are in contact with the first discharge side member 51. Similarly, the second driver ICs 77 are fixed by, for example, bonding in a state in which the second driver ICs 77 are in contact with the second discharge side member 55. The first and second driver ICs 76 and 77 are not always fixed by bonding and may be fixed while being pressed against the first discharge side member 51 and the second discharge side member 55 by a not-shown case of the inkjet head 10.

The inkjet head 10 having the configuration explained above performs printing as explained below.

The ink in the ink tank is supplied to the supply side member 53 through a pipe. The ink flows into the first and second supply passages 64 and 65 through the branching section 66. The ink merges in the merging sections 67 through the first and second supply passages 64 and 65 and is supplied to the ink chamber 25 through the pipes 41 and the pair of supply holes 35 of the manifold 21.

In the ink chamber 25, the ink supplied from the pair of supply holes 35 is supplied to the plural pressure chambers formed by the plural grooves of the pair of driving elements 45. The ink fills the pressure chambers and is supplied to the entire ink chamber 25 through the grooves of the driving elements 45.

The first and second driver ICs 76 and 77 apply, on the basis of a printing signal input by operation by a user, a driving pulse voltage to the electrodes respectively provided in the plural grooves of the driving elements 45 via the wiring patterns 46. When the voltage is applied to the electrodes, the driving elements 45 perform shear mode deformation and increase the pressure in the pressure chambers. Consequently, the ink in the pressure chambers is powerfully but controllably ejected from the nozzles 48. The first and second driver ICs 76 and 77 generate heat according to these operations.

The residual ink after the supply to the ink chamber 25 is discharged from the first discharge holes 36 and the second discharge holes 37. The ink discharged from the first discharge holes 36 and the ink discharged from the second discharge holes 37 return to the ink tank through similar processes. Therefore, the ink discharged from the first discharge holes 36 is representatively explained below.

The ink discharged from the first discharge holes 36 flows into the first discharge passage 62 of the first discharge side member 51 through the pipes 41. The ink charged into the first discharge passage 62 flows through the first discharge passage 62 formed to meander.

Since the first driver ICs 76 are thermally connected to the first discharge side member 51, the first discharge side member 51 absorbs heat generated by the first driver ICs 76. The heat absorbed by the first discharge side member 51 is absorbed by the ink flowing through the first discharge passage 62. The heat is dissipated to, for example, the open air or the case of the inkjet head 10 besides being absorbed by the ink flowing through the first discharge passage 62.

The ink that absorbs the heat from the first discharge side member 51 is returned from the first discharge passage 62 to the ink tank through the pipe. As explained above, the inkjet head 10 performs the printing and the circulation of the ink.

With the inkjet head 10 having the configuration explained above, heat generated from the first and second driver ICs 76 and 77 is absorbed by the ink flowing through the first and second discharge passages 62 and 72. In other words, the first and second driver ICs 76 and 77 are cooled by the circulating ink. Therefore, it is unnecessary to form the cover of the inkjet head 10 in a heat sink shape in order to cool the first and second driver ICs 76 and 77. The structure of the inkjet head 10 can be simplified. Therefore, the manufacturing of the inkjet head 10 in a lost cost and efficient manner is facilitated. It is possible to manufacture the inkjet head 10 inexpensively.

Further, the first and second driver ICs 76 and 77 are respectively thermally connected to the first and second discharge passages 62 and 72 through which the ink discharged from the ink chamber 25 flows. Consequently, it is possible to use the ink discharged from the ink chamber 25, which does not affect printing, to cool the first and second driver ICs 76 and 77.

The first and second discharge side members 51 and 55 are formed of a good conductor of heat, such as a metal such as aluminum. Consequently, it is possible to efficiently cool the first and second driver ICs 76 and 77.

The first rubber plate 52 is interposed between the first discharge side member 51 and the supply side member 53. The second rubber plate 54 is interposed between the supply side member 53 and the second discharge side member 55: Consequently, it is possible to prevent the heat absorbed by the first and second discharge side members 51 and 55 from being transmitted to the supply side member 53 and deteriorating the ink supplied to the ink chamber 25.

The first and second discharge passages 62 and 72 include the grooves formed to meander. Consequently, a contact area between the first and second discharge passages 62 and 72 increases. It is possible to efficiently perform heat conduction from the first and second discharge side members 51 and 55 to the ink.

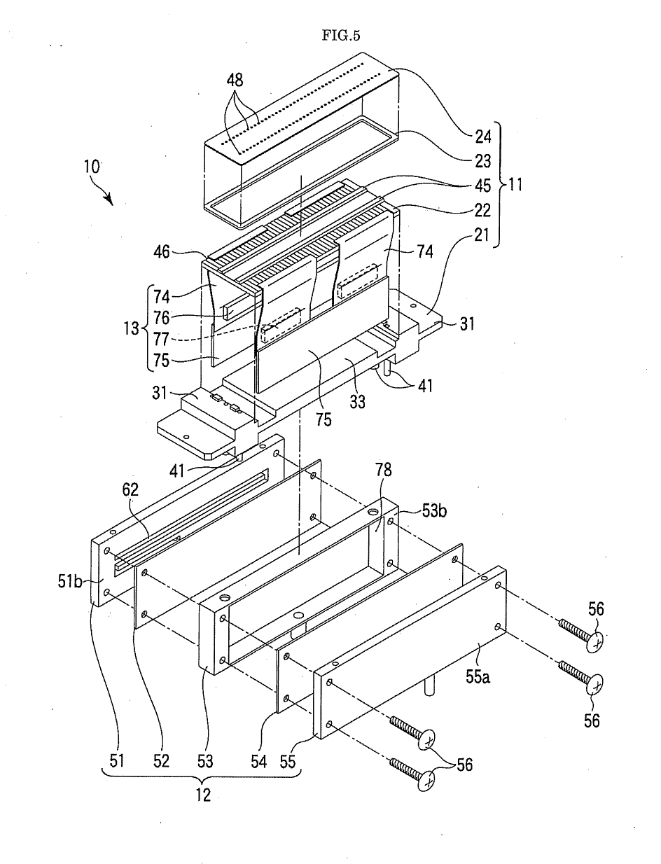

An inkjet head according to a second embodiment is explained below with reference to FIG. 5. In plural embodiments disclosed below, components having functions same as those of the inkjet head 10 according to the first embodiment are denoted by the same reference numerals and signs and explanation of the components is omitted for brevity.

In one aspect, the second embodiment is a modification of the first embodiment. As shown in FIG. 5, the supply side member 53 includes one supply passage 78 instead of the first and second supply passages 64 and 65. In other words, in the supply side member 53 in the second embodiment, the partition wall separating the first supply passage 64 and the second supply passage 65 is removed.

Even when the partition wall separating the first supply passage 64 and the second supply passage 65 is removed as explained above, as in the inkjet head 10 according to the first embodiment, the first and second driver ICs 76 and 77 can be cooled by the circulating ink.

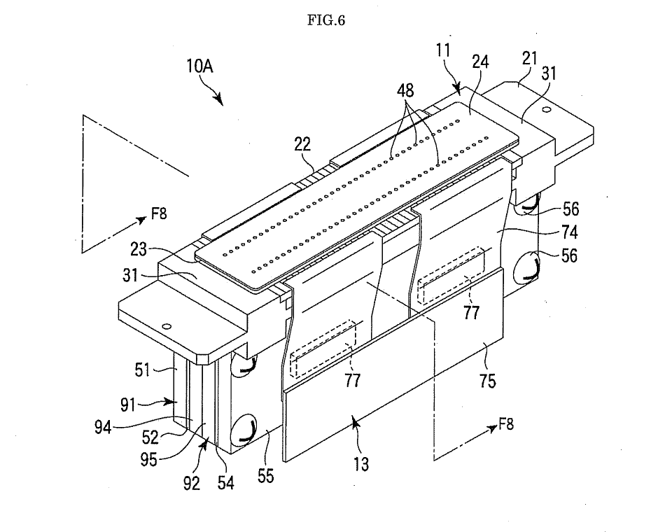

An inkjet head according to a third embodiment is explained below with reference to FIGS. 6 to 9.

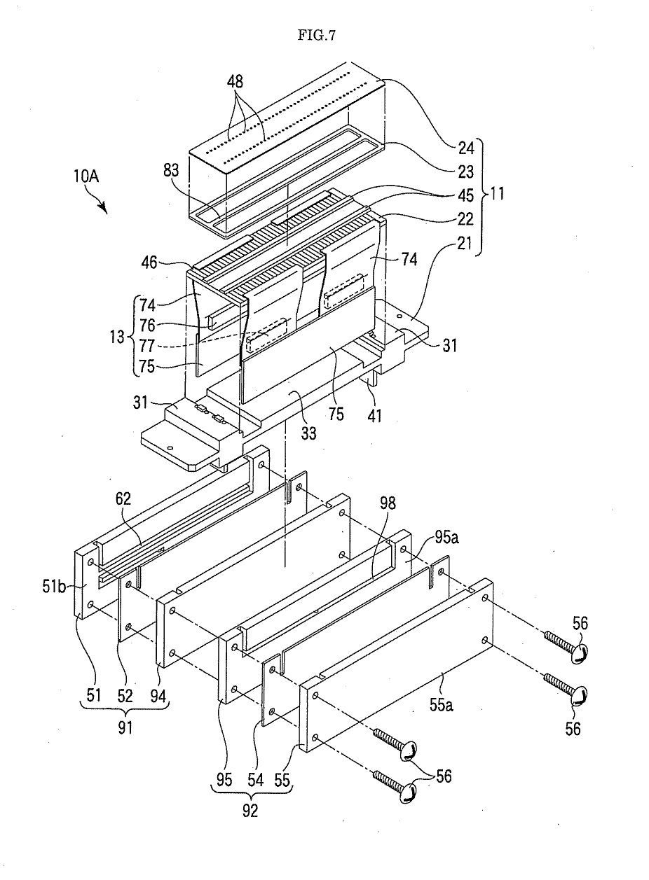

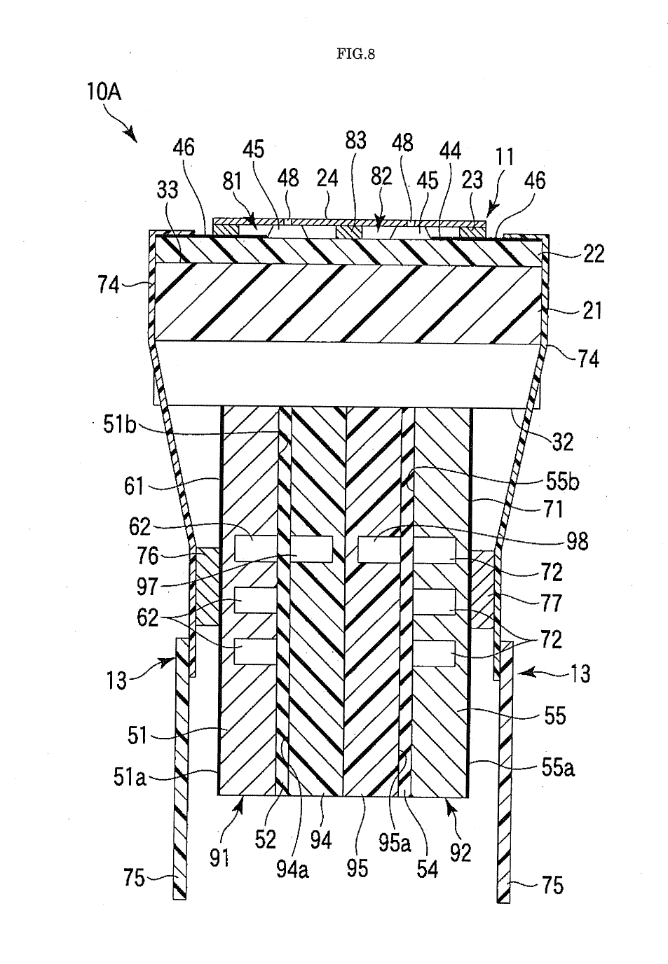

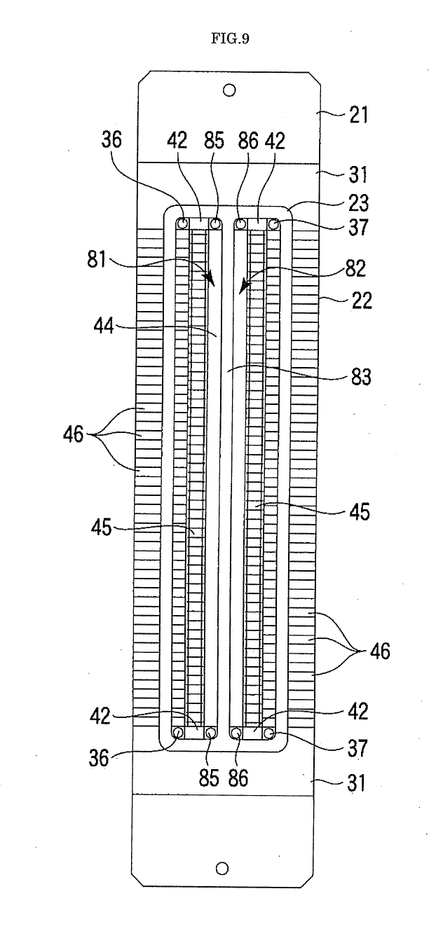

FIG. 6 is a perspective view of an inkjet head 10A according to the third embodiment. FIG. 7 is a disassembled perspective view of the inkjet head 10A. FIG. 8 is a sectional view of the inkjet head 10A taken along line F8-F8 shown in FIG. 6. FIG. 9 is a plan view of the manifold 21, the substrate 22, and the frame member 23. The inkjet head 10A according to the third embodiment is an inkjet head that ejects inks of two colors.

As shown in FIG. 8, the inkjet head 10A includes a first ink chamber 81 and a second ink chamber 82 instead of the ink chamber 25 in the first embodiment. First ink of a first color, for example, cyan is supplied to the first ink chamber 81. Second ink of a second color, for example, magenta is supplied to the second ink chamber 82. The colors of the inks are not limited to these colors as long as the color of the first ink and the color of the second ink are different from each other.

The driving elements 45 are respectively provided in the first ink chamber 81 and the second ink chamber 82. The driving element 45 provided in the first ink chamber 81 is electrically connected to the first driver ICs 76. The driving, element 45 provided in the second ink chamber 82 is electrically connected to the second driver ICs 77. The nozzles 48 are respectively opened to the first ink chamber 81 and the second ink chamber 82.

As shown in FIG. 9, the frame member 23 has an inner frame section 83. The inner frame section 83 is arranged between the pair of driving elements 45 and separates the first ink chamber 81 from the second ink chamber 82.

The manifold 21 includes a pair of first supply holes 85 and a pair of second supply holes 86 instead of the pair of supply holes 35 in the first embodiment. The pair of first discharge holes 36 and the pair of first supply holes 85 are opened to the first ink chamber 81. The pair of second discharge holes 37 and the pair of second supply holes 86 are opened to the second ink chamber 82. The first and second supply holes 85 and 86 respectively communicate with the pipes 41 corresponding thereto.

As shown in FIG. 6, the inkjet head 10A includes a first ink passage section 91 and a second ink passage section 92. As shown in FIG. 7, the first ink passage section 91 includes the first discharge side member 51, the first rubber plate 52, and a first supply side member 94. The second ink passage section 92 includes a second supply side member 95, the second rubber plate 54, and the second discharge side member 55.

The first and second supply side members 94 and 95 are formed of a suitable material in a suitable shape, for example, resin in a rectangular block shape. The first and second supply side members 94 and 95 can be formed of the same as the material of the first discharge side member 51, such as aluminum or other materials.

As shown in FIG. 8, the first supply side member 94 includes a first supply passage 97. The first supply passage 97 includes a groove opened in an inner surface 94a of the first supply side member 94. One end of the first supply passage 97 is a pair of recesses opened in one end face of the first supply side member 94. The pipes 41 of the manifold 21 communicating with the first supply holes 85 are respectively inserted into the recesses. The other end of the first supply passage 97 is connected to a first ink tank in which the first ink is stored. The first supply passage 97 is connected to the first ink chamber 81. The first ink supplied from the first ink tank to the first ink chamber 81 passes through the first supply passage 97.

The second supply side member 95 includes a second supply passage 98. The second supply passage 98 includes a groove opened in an inner surface 95a of the second supply side member 95. One end of the second supply passage 98 is a pair of recesses opened in one end face of the second supply side member 95. The pipes 41 of the manifold 21 communicating with the second supply holes 86 are respectively inserted into the recesses. The other end of the second supply passage 98 is connected to a second ink tank in which the second ink is stored. The second supply passage 98 is connected to the second ink chamber 82. The second ink supplied from the second ink tank to the second ink chamber 82 passes through the second supply passage 98.

As shown in FIG. 6, the first ink passage section 91 and the second ink passage section 92 are arranged side by side and attached to the ink ejecting section 11. At this point, the first supply side member 94 and the second supply side member 95 are arranged side by side. The first and second discharge side members 51 and 55 are respectively arranged on the outer sides of the first and second supply side members 94 and 95 adjacent to each other.

The inkjet head 10A performs printing as explained below. The first ink and the second ink circulate in similar processes. Therefore, only the first ink is representatively explained below.

The first ink in the first ink tank is supplied to the first supply side member 94 through a pipe. The first ink flows into the first supply passage 97. The first ink passes through the first supply passage 97 and is supplied to the first ink chamber 81 through the pipes 41 and the pair of first supply holes 85 of the manifold 21.

In the first ink chamber 81, the first ink supplied from the pair of first supply holes 85 is supplied to the plural pressure chambers formed by the plural grooves of the driving elements 45. The first ink fills the pressure chambers and is supplied to the entire first ink chamber 81 through the grooves of the driving elements 45.

The first driver ICs 76 apply, on the basis of a printing signal input by operation by a user, a driving pulse voltage to the electrodes respectively provided in the plural grooves of the driving elements 45 via the wiring patterns 46. When the voltage is applied to the electrodes, the first ink in the pressure chambers is powerfully but controllably ejected from the nozzles 48. Consequently, printing of cyan is performed. Similarly, the second ink in the second ink chamber 82 is ejected from the nozzles 48 and printing of magenta is performed.

The residual first ink after the supply to the first ink chamber 81 is discharged from the first discharge holes 36. The first ink discharged from the first discharge holes 36 is used for cooling of the first driver ICs 76 and returned to the first ink tank in the same manner as the ink in the first embodiment.

With the inkjet head 10A having the configuration explained above, even if inks of two colors are used, as in the inkjet head 10 according to the first embodiment, it is possible to cool the first and second driver ICs 76 and 77 with the circulating inks.

The first and second discharge side members 51 and 55 are respectively arranged on the outer sides of the first and second supply side members 94 and 95 adjacent to each other. Consequently, the first and second driver ICs 76 and 77 are easily brought into contact with the first and second discharge side members 51 and 55.

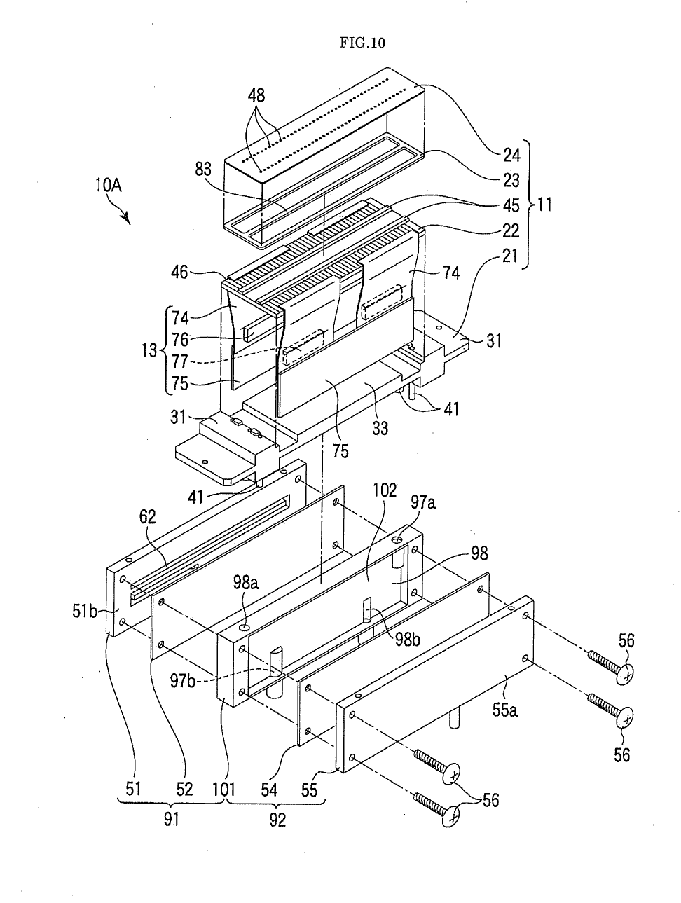

An inkjet head according to a fourth embodiment is explained below with reference to FIG. 10. In plural embodiments disclosed below, components having functions same as those of the inkjet head 10A according to the third embodiment are denoted by the same reference numerals and signs and explanation of the components is omitted for brevity.

in one aspect, the fourth embodiment is a modification of the third embodiment. As shown in FIG. 10, the inkjet head 10A includes one supply side member 101 instead of the first and second supply side members 94 and 95. Therefore, the first ink passage section 91 and the second ink passage section 92 are integrally formed.

The supply side member 101 includes the first supply passage 97, the second supply passage 98, and a partition wall 102. The partition wall 102 separates the first supply passage 97 from the second supply passage 98.

One end 97a of the first supply passage 97 is a hole opened in one end face of the supply side member 101. The pipe 41 of the manifold 21 communicating with the first supply hole 85 is inserted into the hole. The other end 97b of the first supply passage 97 is connected to the first ink tank in which the first ink is stored. A space between both the ends 97a and 97b of the first supply passage 97 and the second supply passage 98 is closed.

One end 98a of the second supply passage 98 is a hole opened in one end face of the supply side member 101. The pipe 41 of the manifold 21 communicating with the second supply hole 86 is inserted into the hole. The other end 98b of the second supply passage 98 is connected to the second ink tank in which the second ink is stored. A space between both the ends 98a and 98b of the second supply passage 98 and the first supply passage 97 is closed.

Even when the first ink passage section 91 and the second ink passage section 92 are integrally formed as explained above, as in the inkjet head 10A according to the third embodiment, it is possible to cool the first and second driver ICs 76 and 77 with the circulating ink.

In the plural embodiments explained above, the cases of the inkjet heads 10 and 10A can be formed in a heat sink shape and thermally connected to the first and second discharge side members 51 and 55.

The ink passage section 12 in the first embodiment includes the first and second rubber plates 52 and 54. However, the ink passage section 12 is not limited to this construction. For example, if the first discharge passage 62 is sealed by the supply side member 53 and the first supply passage 64 is sealed by the discharge side member 51, the first rubber plate 52 advantageously does not have to be provided. If the second supply passage 65 is sealed by the second discharge side member 55 and the second discharge passage 72 is sealed by the supply side member 53, the second rubber plate 54 advantageously does not have to be provided.

In the embodiments, the driver ICs are thermally connected to the discharge side member. However, the driver ICs can be thermally connected to the supply side member. In this case, the driver ICs are cooled by the ink supplied from the ink tank and passing through the supply passage.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An inkjet head comprising:
an ink ejecting section including an ink chamber to which ink is supplied, a driving element provided in the ink chamber, a nozzle opened to the ink chamber, and a wire connected to the driving element, the ink ejecting section being configured to eject the ink in the ink chamber from the nozzle using the driving element;
an ink passage section attached to the ink ejecting section and including a supply passage, is connected to the ink chamber and through which the ink supplied to the ink chamber passes, and a discharge passage, which is connected to the ink chamber and through which the ink discharged from the ink chamber passes; and
an integrated circuit (IC) electrically connected to the driving element via the wire and thermally connected to the ink passage section.

2. The inkjet head according to claim 1, wherein
the ink passage section includes a supply side member including the supply passage and a discharge side member including the discharge passage, and
the IC is thermally connected to the discharge side member.

3. The inkjet head according to claim 2, wherein the discharge side member is a heat conductor.

4. The inkjet head according to claim 3, wherein the ink passage section further includes a heat insulating member interposed between the supply side member and the discharge side member.

5. The inkjet head according to claim 4, wherein the discharge passage is formed to meander.

6. An inkjet head comprising:
an ink ejecting section including a first ink chamber to which first ink is supplied, a second ink chamber to which second ink of a color different from a color of the first ink is supplied, plural driving elements respectively provided in the first ink chamber and the second ink chamber, plural nozzles respectively opened to the first ink chamber and the second ink chamber, and plural wires connected to the plural driving elements, the ink ejecting section being configured to eject the first ink in the first ink chamber and the second ink in the second ink chamber from the plural nozzles using the plural driving elements;
a first ink passage section attached to the ink ejecting section and including a first supply passage, is connected to the first ink chamber and through which the first ink supplied to the first ink chamber passes, and a first discharge passage, which is connected to the first ink chamber and through which the first ink discharged from the first ink chamber passes;
a second ink passage section attached to the ink ejecting section and including a second supply passage, is connected to the second ink chamber and through which the second ink supplied to the second ink chamber passes, and a second discharge passage, which is connected to the second ink chamber and through which the second ink discharged from the second ink chamber passes; and
plural (ICs) electrically connected to the plural driving elements via the plural wires and respectively thermally connected to the first ink passage section and the second ink passage section.

7. The inkjet head according to claim 6, wherein
the first ink passage section includes a first supply side member including the first supply passage and a first discharge side member including the first discharge passage,
the second ink passage section includes a second supply side member including the second supply passage and a second discharge side member including the second discharge passage, and
the plural ICs are respectively thermally connected to the first discharge side member and the second discharge side member.

8. The inkjet head according to claim 7, wherein the first discharge side member and the second discharge side member are heat conductors.

9. The inkjet head according to claim 8, wherein the first ink passage section further includes a first heat insulating member interposed between the first supply side member and the first discharge side member.

10. The inkjet head according to claim 9, wherein
the first ink passage section and the second ink passage section are arranged side by side, and
the first discharge side member and the second discharge side member are respectively arranged on outer sides of the first supply side member and the second supply side member adjacent to each other.
